(19) United States
(12) Patent Application Publication
(10) Pub. No.: US 2018/0182589 A1
(43) Pub. Date: Jun. 28, 2018

(54) X-RAY TUBE DEVICE AND NEGATIVE ELECTRODE

(71) Applicant: SHIMADZU CORPORATION, KYOTO (JP)

(72) Inventor: TAKUMI KOBAYASHI, KYOTO (JP)

(73) Assignee: SHIMADZU CORPORATION, KYOTO (JP)

(21) Appl. No.: 15/737,933

(22) PCT Filed: Jun. 24, 2015
(86) PCT No.: PCT/JP2015/068255

§ 371 Date: Dec. 19, 2017

(51) Int. Cl. H01J 35/06

(52) U.S. Cl. CPC H01J 35/06

(57) ABSTRACT

An X-ray tube device includes an anode (2) and a cathode (1) that emits an electron to the anode. The cathode has an electron emission element (11) having an electric pathway (111) formed as a flat-plate; one pair of terminals connected to the electrode, and support members (13a, 13b) that support an electron emission element independently installed from the terminal and insulated against the electrodes. The terminals include an enlargement member (121, 122) in which a cross-section area in the orthogonal direction to the extending direction of the terminals, is larger than the cross-section area of the electric current pathway in the orthogonal direction to the extending direction of the electric current pathway.

### CROSS REFERENCE TO RELATED APPLICATIONS

This application relates to, and claims priority from SN PCT/JP2015/068255 filed Jun. 24, 2015, the entire contents of which are incorporated herein by reference.

### FIGURE SELECTED FOR PUBLICATION

FIG. 8

### BACKGROUND OF THE INVENTION

### Field of the Invention

The present invention relates to an X-ray tube device and a negative electrode (cathode).

### Description of the Related Art

Conventionally, an X-ray tube device is known. Such X-ray tube device is disclosed in Japanese Patent Published: WO2014/041639 A1, for example.

The x-ray tube device disclosed in the above WO2014/041639 A1 comprises an anode (positive electrode) and a cathode (negative electrode) that emits an electron toward the anode. In addition, the cathode comprises: an electron emission element that emits the electron, which has an electric pathway formed into a plate; a pair of terminals connected to the electrode, which is respectively extending from the electron emission element; and a support member that supports an electron emission element, which is independently installed from the terminal and insulated against the electrodes.

### RELATED PRIOR ART DOCUMENTS

### Patent Document

Patent Document 1: WO2014/041639A1

### ASPECTS AND SUMMARY OF THE INVENTION

### Objects to be Solved

According to the X-ray tube device of the above Patent Document WO2014/041639 A1, the support member supports the electron emission element, so that the electron emission element is prevented to be deformed. However, when the electron emission element is energized, the heat of the electron emission element dissipates through the support member supporting the electron emission element, so that the temperatures of the support member and the proximity of the portion to which the support member of the electron emission element is connected become lower, but on the other hand, the temperatures of the terminal and the proximity to which the terminal of the electron emission element is connected become higher. As results, the temperature of the electron emission element may become uneven. Therefore, it is desirable that an X-ray tube device and a cathode can prevent the temperature of the electron emission element to become uneven while preventing deformation of the electron emission element.

The present invention intends to solve the problem as set forth above and one of the purposes of the present invention is to provide an X-ray tube device and a cathode can prevent the temperature of the electron emission element to become uneven while preventing deformation of the electron emission element.

### Means for Solving the Problem

The cathode of the X-ray tube device that emits an electron toward the anode and emits the electron by energizing and heating comprises an electron emission element having an electric current pathway formed into a flat-plate; a pair of terminals extending respectively from the electron emission element and being connected to the electrode; a support member that is separately installed from the terminals, is insulated against the electrode, and supporting the electron emission element; wherein the terminals include an enlargement member having an cross-section area, which is the cross-section area thereof in the orthogonal direction to the extending direction of the terminals, is larger than the cross-section area of the electric current pathway in the orthogonal direction to the extending direction of the electric current pathway. In addition, an X-ray tube device with an aspect, in which the above cathode and the above anode are installed, can be provided.

When the cross-section area of the enlargement member is large, an electric resistance decreases, so that the heat generation relative to the terminal on energizing can be lowered. In addition, when the cross-section area of the enlargement member is large, an electric conductivity of the enlargement member increases, so that the heat conduction (heat dissipation) amount through the terminal of the electron emission element can be increased. In addition, the surface area of the enlargement member can be increased along increase of the cross-section area of the enlargement member, so that the heat emission amount based on the radiation relative to the enlargement member can be increased. Therefore, temperature rising of the terminal relative to the support member can be prevented to be relatively high. As results, the temperature rising of the proximity of the portion connected to the terminal of the electron emission element can be prevented to be relatively high compared to the temperature of the proximity of the portion connected to the support member of the electron emission element, so that the temperature of the electron emission element can be prevented to be uneven. Therefore, the electron emission element can be prevented to have locally high-temperature, so that a wire-breaking lifetime of the electron emission element can be prevented to be short. In addition, the electron emission element can emit uniform electrons. In addition, the support member supports the electron emission element, so that the electron emission element is prevented to be deformed. Consequently, the temperature of the electron emission element can be prevented to become uneven while preventing deformation of the electron emission element.

It is preferable that the terminal is formed into a flat-plate shape, and an outer circumference length of the cross-section of the enlargement member in the orthogonal direction to the extending direction of the enlargement member is longer than an outer circumference length of the cross-section of the electric current pathway in the orthogonal direction to the extending direction of the electric current pathway. According to such structure, the surface area of the enlargement member per unit volume can be increased, so that the heat emission amount based on the radiation relative to the enlargement member can be increased easily.

It is preferable that the terminal is formed so that the proximity of the portion connected to the electron emission element has a smaller cross-section area than the enlargement member. According to such structure, the cross-section area of the fold portion can be avoided to become large when the electron emission element and the terminal are formed in a unified manner by folding the boarder therebetween, so that such folding can be achieved easily. In addition, when the cathode is covered with a cover, it can be prevented that the area connected to the electron emission element of the terminal interferes the cover.

It is preferable that the enlargement member is formed into a flat-plate shape, and formed to enlarge in the width direction or the thickness direction of the direction orthogonal to the extending direction of the flat-plate-shaped enlargement member. The terminal is formable into the flat-plate having approximately the same thickness given the aspect is enlarging in the width direction, so that the enlargement member can be easily formed.

It is preferable that the enlargement member comprises a first member extending in a first direction intersecting relative to the electron emission element and a second member connected to the first member is extending in a second direction intersecting with the first direction. According to such structure, the volume of the enlargement member can be increased by combining the first member and the second member, so that it can be effectively prevented that the temperature of the terminal becomes relatively high.

It is preferable that the support member is formed so that the cross-section area in the orthogonal direction to the extending direction of the support member is smaller than the cross-section area of the electric current pathway in the orthogonal direction to the extending direction of the electric current pathway. According to such structure, heat dissipation from the electron emission element via the support member can be prevented, so that it can be prevented that the temperature of the proximity of the member connecting the support member of the electron emission element is relatively lower than the temperature of the proximity of the member connecting the terminal of the electron emission element. Consequently, the temperature of the electron emission element can be prevented to become uneven.

### Effect of the Invention

As set forth above, according to the present invention, an X-ray tube device and a cathode that can prevent the temperature of the electron emission element to become uneven while preventing deformation of the electron emission element can be provided.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a schematic view illustrating an entire structure of an X-ray tube device according to the aspect of the Embodiment 1.

FIG. 1 is a schematic perspective view illustrating a structure of a cathode of the X-ray tube device according to the aspect of the Embodiment 1.

FIG. 3 is a front view illustrating a structure of the cathode of the X-ray tube device according to the aspect of the Embodiment 1.

FIG. 4 is a plan view illustrating the structure of the cathode of the X-ray tube device according to the aspect of the Embodiment 1.

FIG. 5 is a side view illustrating the structure of the cathode of the X-ray tube device according to the aspect of the Embodiment 1.

FIG. 6 is a view illustrating a simulation result of temperature distribution of the cathode of the X-ray tube device according to the aspect of the Embodiment.

FIG. 7 is a schematic perspective view illustrating a structure of a cathode of an X-ray tube device according to the aspect of the Embodiment 2.

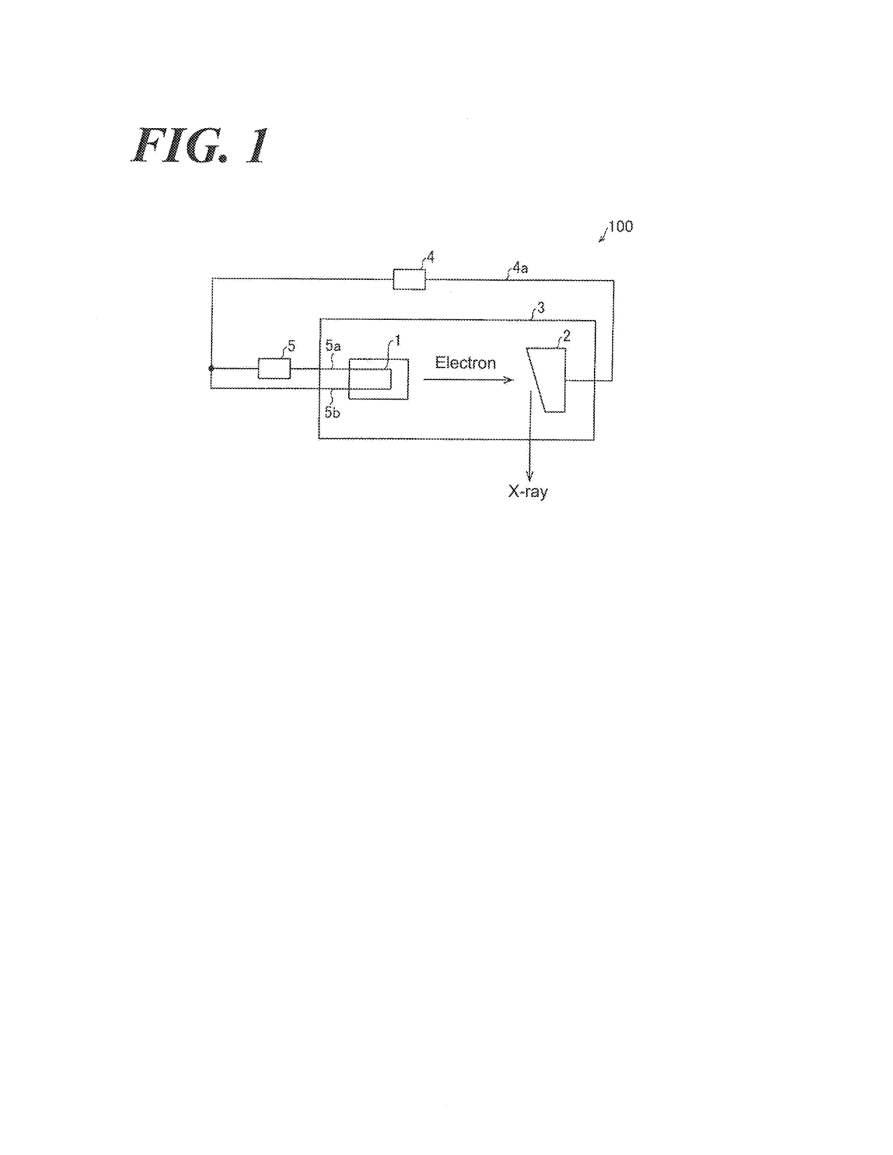

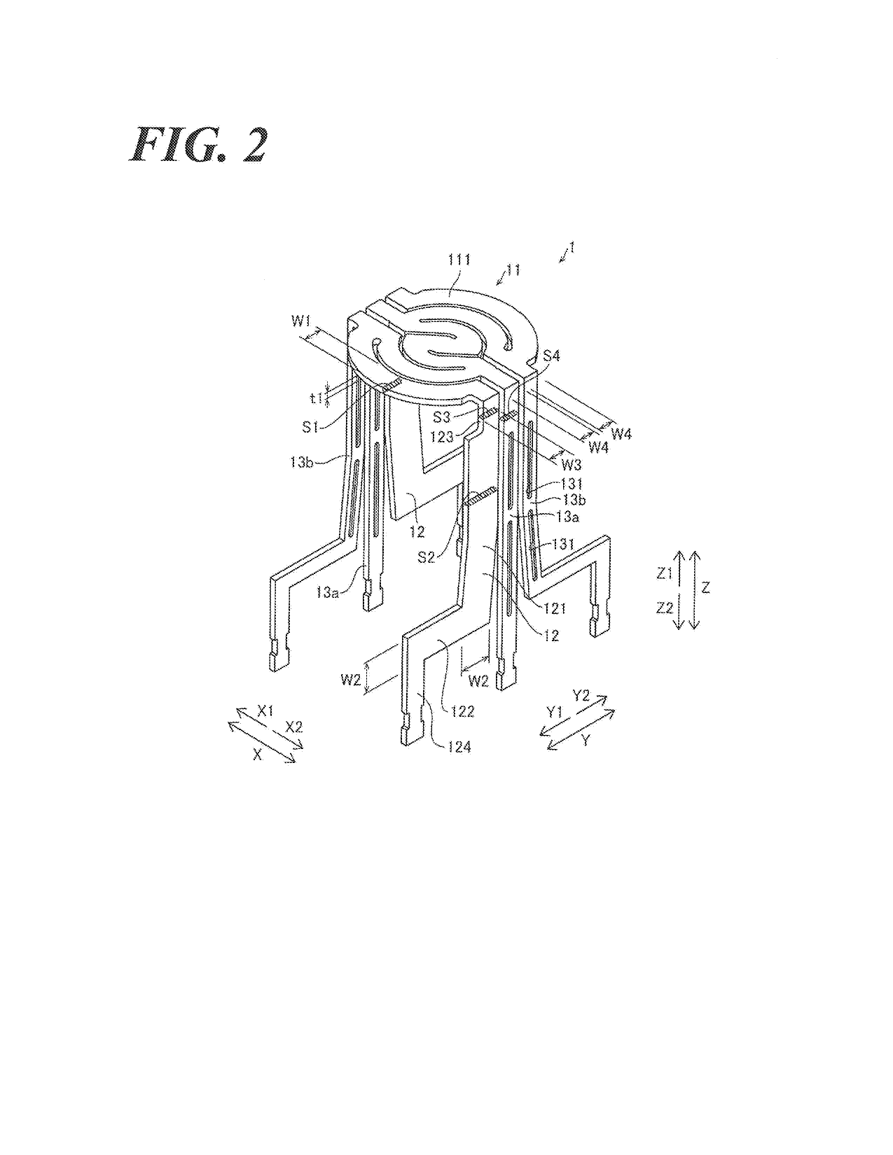

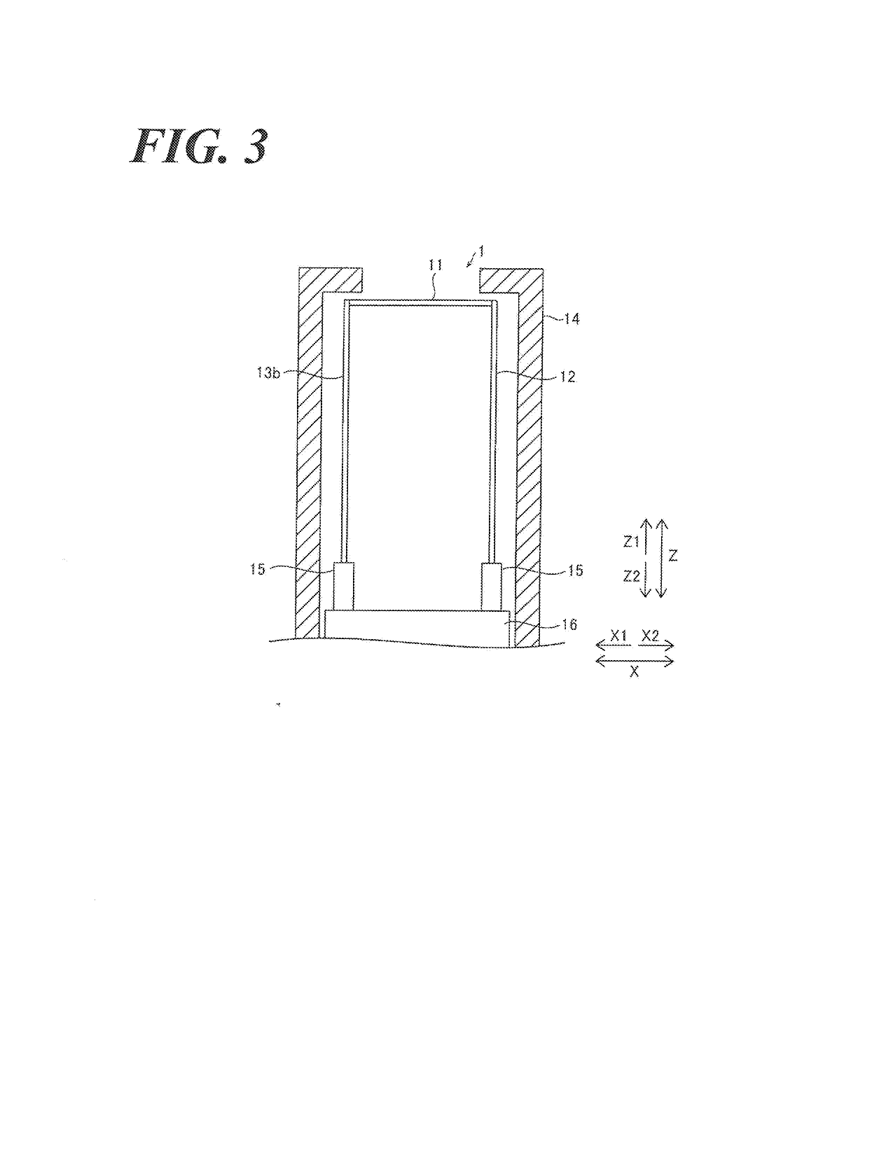

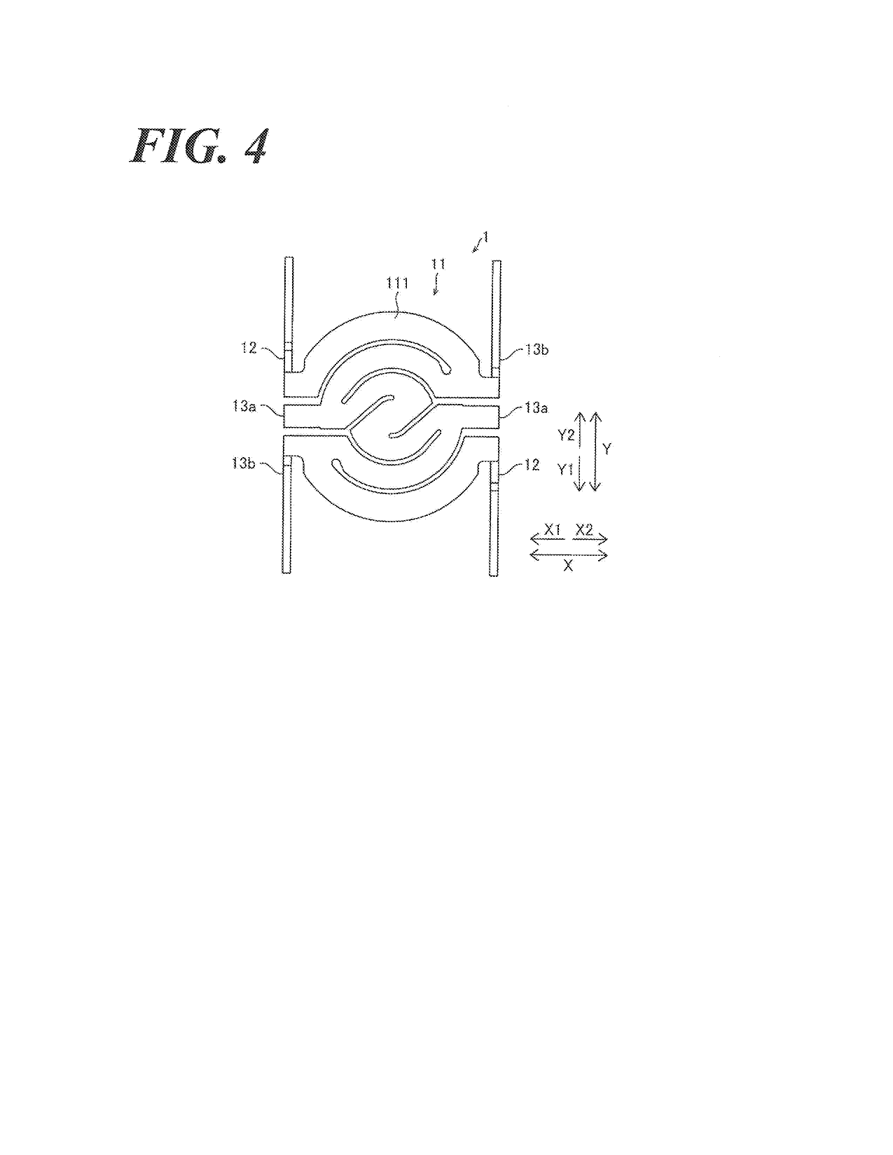

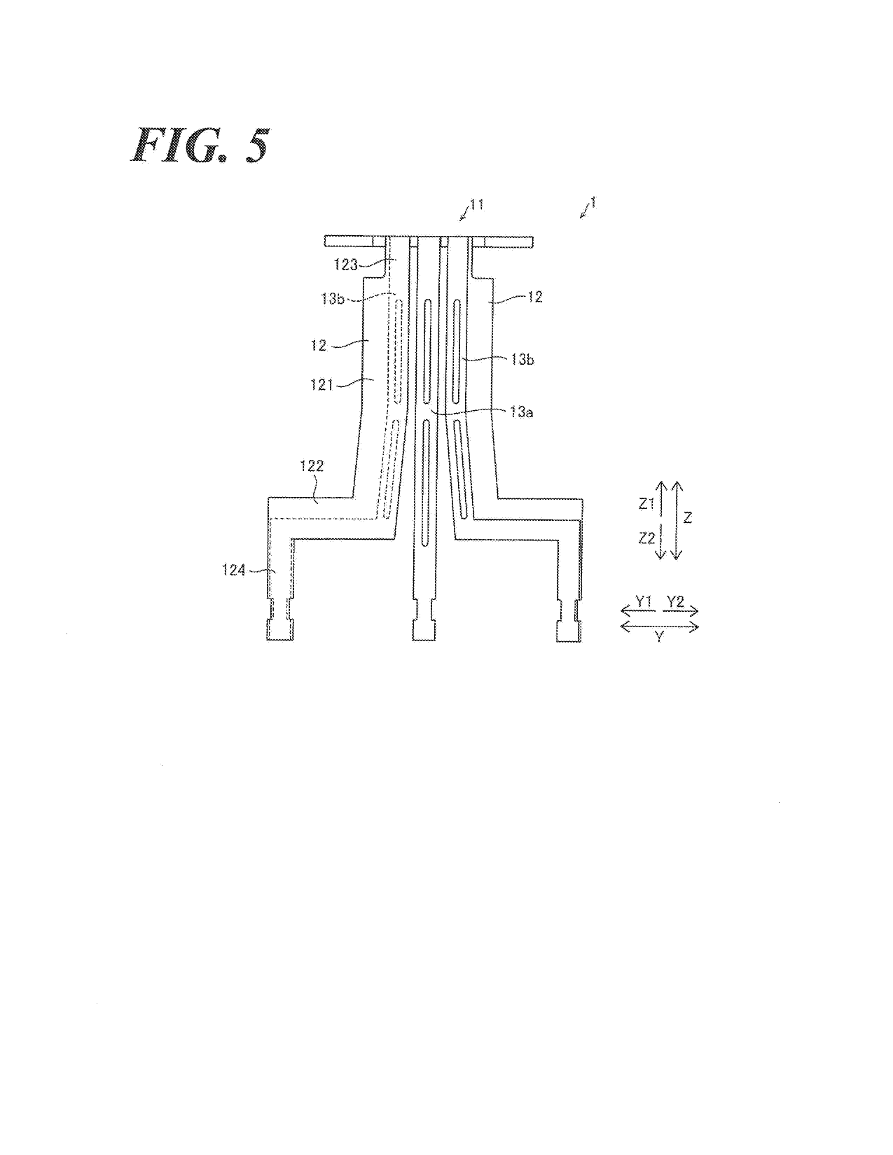

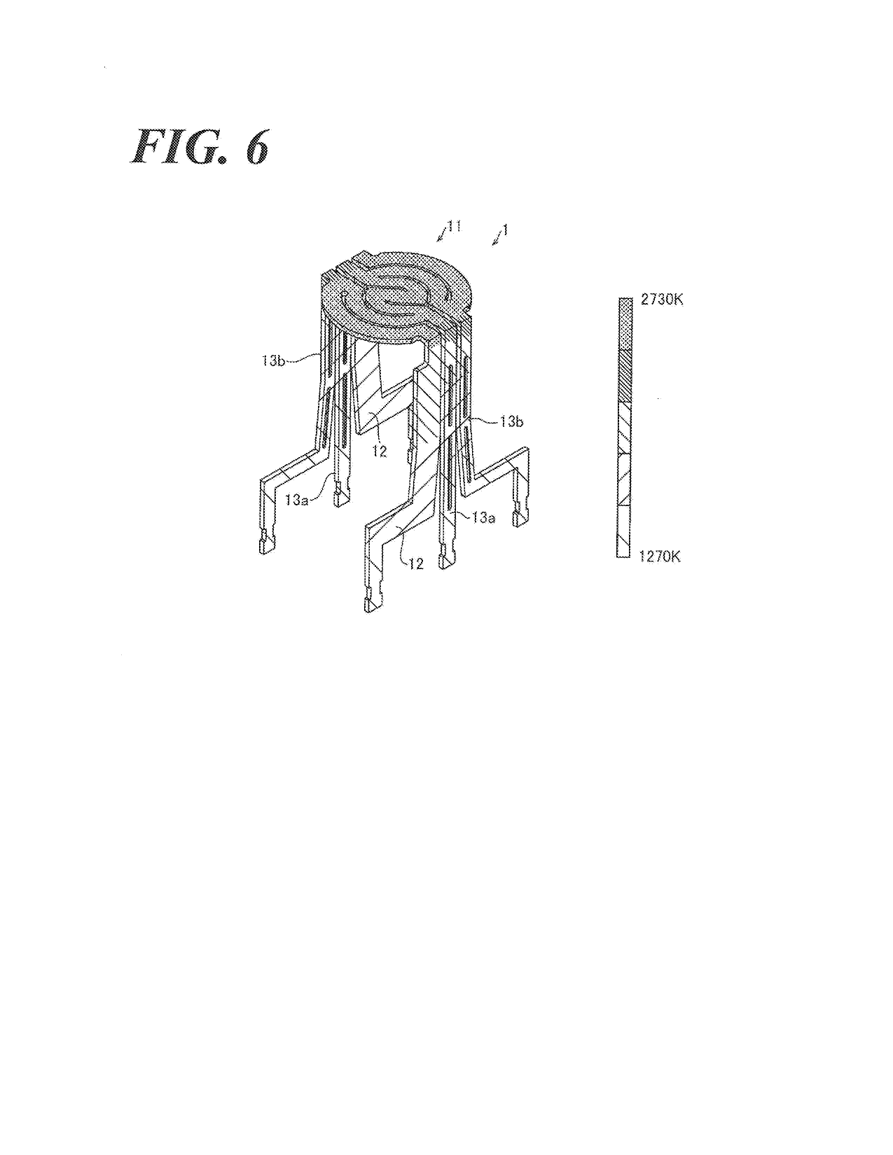

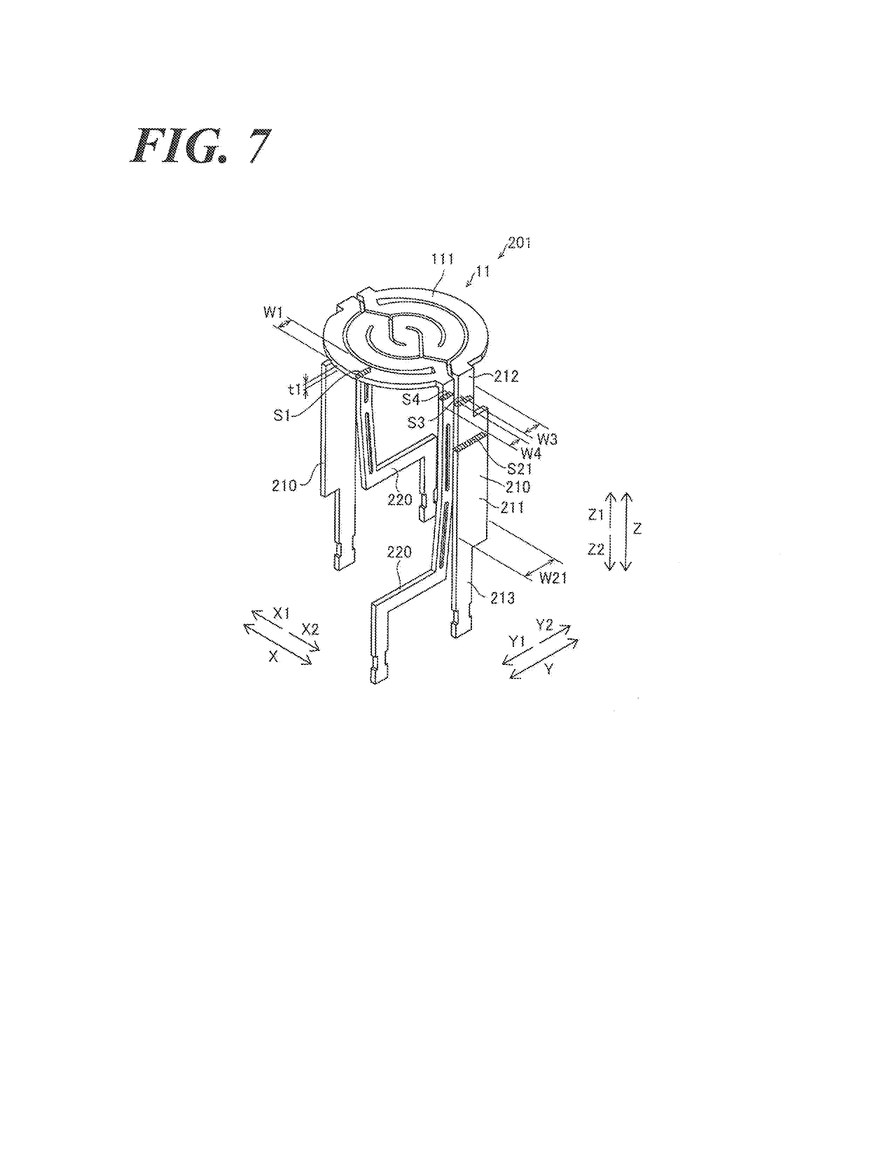

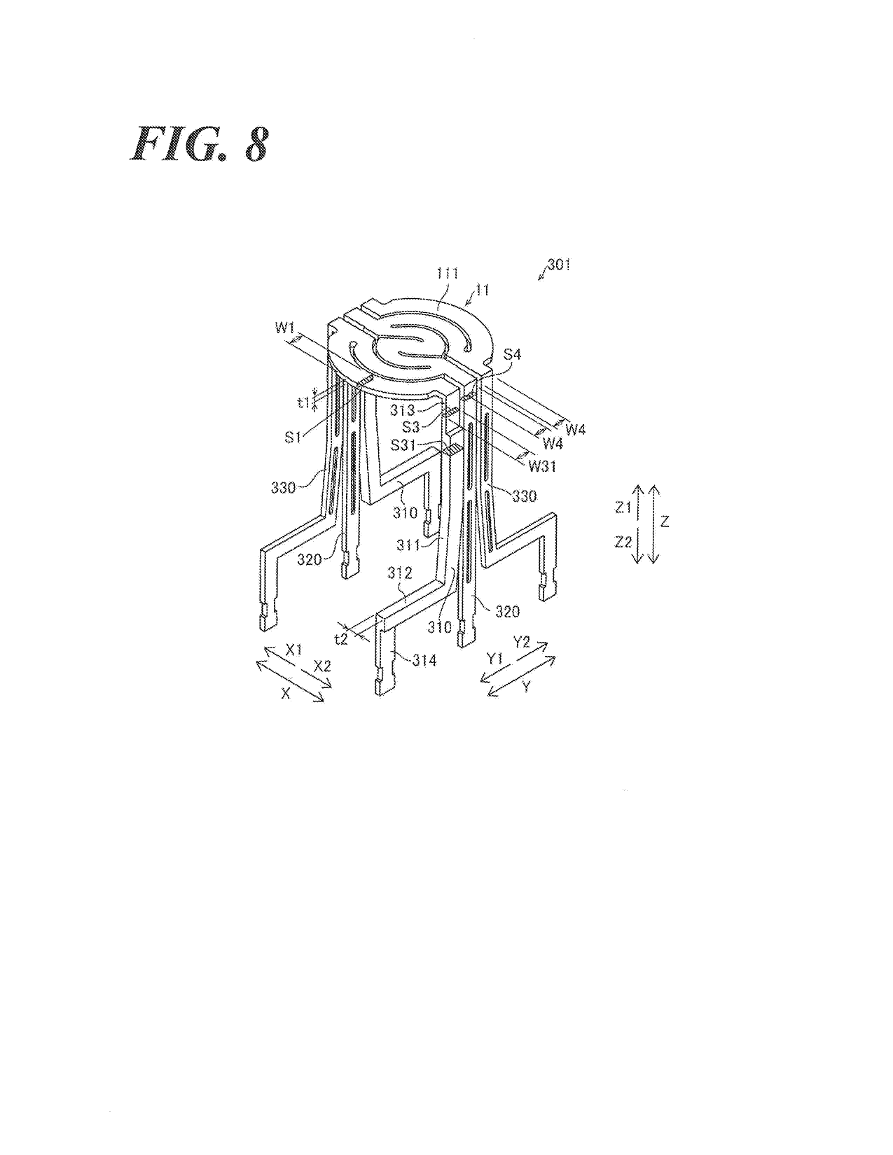

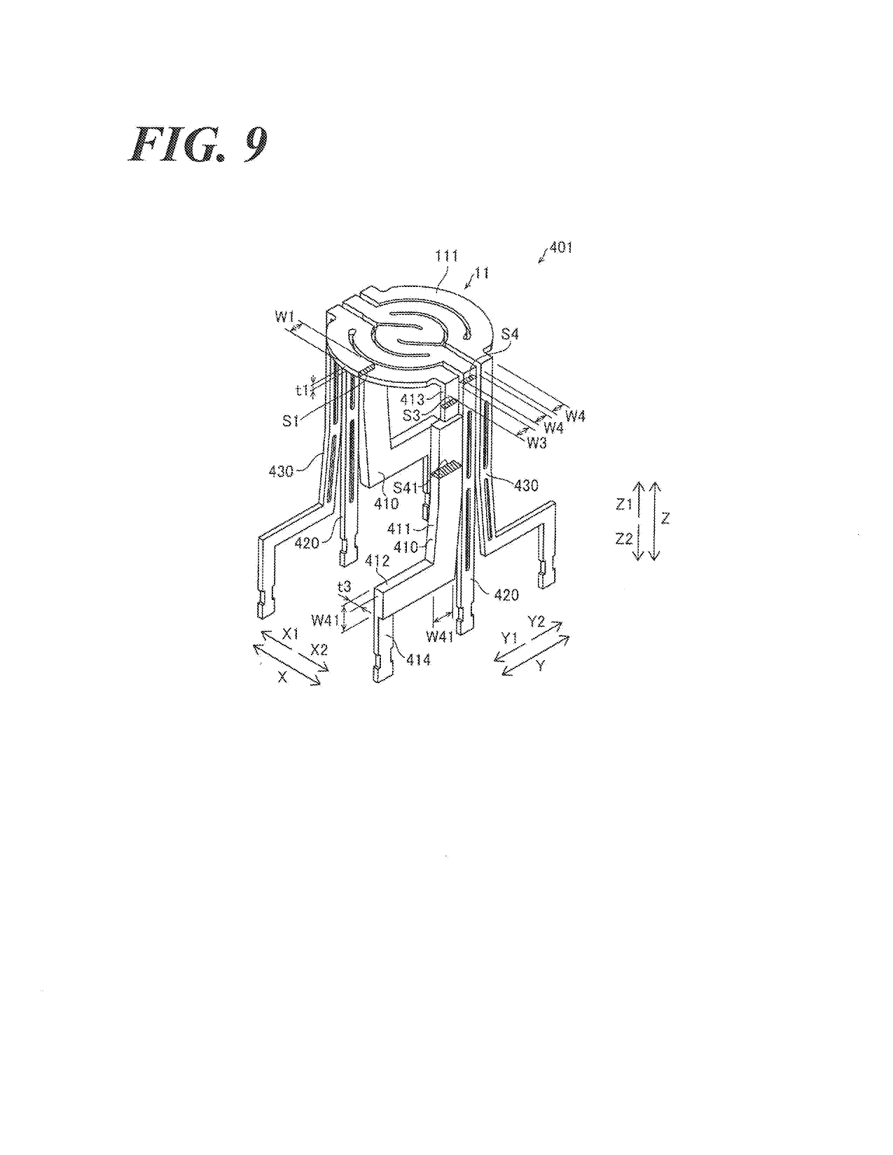

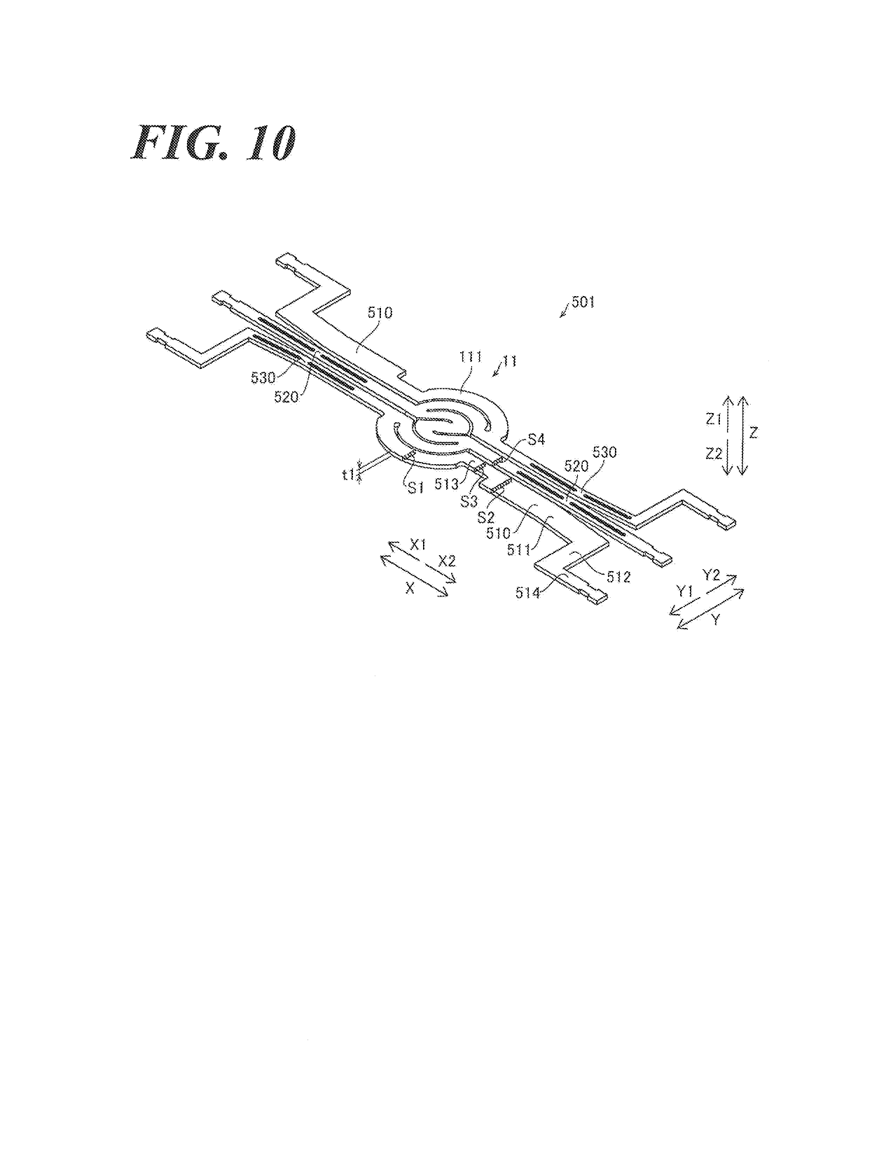

FIG. 8 is a schematic perspective view illustrating a structure of a cathode of an X-ray tube device according to the aspect of the Embodiment 3.

FIG. 9 is a schematic perspective view illustrating a structure of a cathode of an X-ray tube device according to the aspect of the Embodiment 4.

FIG. 10 is a schematic perspective view illustrating a structure of a cathode of an X-ray tube device according to the aspect of the alternative Embodiment of the Embodiment 1.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

### Embodiment 1

[System of an X-Ray Imaging Apparatus]

First, referring to FIG. 1, the inventor illustrates the system of the X-ray tube device 100 according to the aspect of the Embodiment 1.

Referring to FIG. 1, an X-ray tube device 100 emits an X-ray. In addition, the X-ray tube device 100 comprises a cathode 1 that emits an electron beam, a target 2, an envelope 3 (container) housing the cathode 1 and the target 2, a power source circuit 4 and 5. Further, the target 2 is an example of “an anode” of the claim.

The cathode 1 emits an electron toward the target 2. The cathode 1 is in place facing the target 2. In addition, a predetermined voltage is added in between the cathode 1 and the target 2 by the power source 4. Specifically, the cathode 1 and the target 2 are connected to the power source circuit 4 via a wire 4a and a relatively positive voltage is added to the target 2 compared to the cathode 1. In addition, the cathode 1 is connected to the power source circuit 5 via wires 5a and 5b. And, the cathode 1 is energized by the power source circuit 5. Accordingly, an electron beam (thermoelectron) is emitted from the cathode 1 toward the target 2.

The target 2 is made of a metal. For example. the target 2 is made of the metal material such as copper, molybdenum, cobalt, chrome, iron, silver and so forth. The target 2 emits an X-ray when the electron beam (thermoelectron) emitted from the cathode 1 is impacted thereto.

The cathode 1 and the target 2 are in place in the envelope 3. The inside of the envelope 3 is under vacuum. The envelope 3 is made of non-magnetic metal material such stainless (SUS) and so forth. In addition, the envelope 3 has a window through which an X-ray is emitted to outside.

(Structure of a Cathode)

Next, the inventor sets forth the structure of the cathode 1 in detail. Referring to FIG. 2-FIG. 5, the cathode 1 that is made of pure tungsten or a tungsten alloy comprises a flat-plate shape electron emission element 11 and one pair of terminals 12, two pairs of support members 13a, 13b in a unified manner. Specifically, the electron emission element 11, the terminals 12, the support members 13a, 13b are made of the same materials in a unified manner. According to the Embodiment 1, the electron emission element 11, one pair of the terminals 12, two pairs of the support members 13a, 13b are cutout from a single flat-plate material by using a laser and formed by a bending work in a unified manner. The electron emission element 11 comprises an electric current pathway 111. The terminal 12 comprises enlargement members 121, 123, a connection member 123 and an electrode connection member 124. Further, the enlargement members 121, 123 are respectively examples of a “first member” and a “second member” in the claims.

The cathode 1 is so to speak a thermoelectron emission type emitter and heated by energizing through the pair of terminals 12. Accordingly, the flat-plate shape electron emission element 11 is heated to a predetermined temperature (approximately 2400K-approximately 2700K) by energizing, so that an electron from the electron emission element is emitted. Referring to FIG. 3, the cathode 1 is covered by a cover made of metal. In addition, the terminal 12 and the support members 13a, 13b are fixed to an electrode bars 15. The electrode bars 15 on a ceramic base 16 are fixed in the predetermined distance with each other. Wires 5a, 5b (referring to FIG. 1) are connected to the electrode bar 15 to which one pair of the terminals 12 is fixed,

Referring to FIG. 2, FIG. 4, the electron emission element 11 is formed into a flat-plate shape with the electric current pathway 111 having a winding form (meander form). The electron emission element looks circular in a plane view (view in the Z-direction).

Referring to FIG. 2, the electric current pathway 111 have an approximately constant pathway width W1. The electric current pathway 111 is formed as a flat-plate shape having an approximately constant thickness t1. Both ends of the electric current pathway 111 have the cross-section area S1 in the orthogonal direction to the extending direction of the electric current pathway 111. Both ends of the electric current pathway 111 are respectively connected to the terminals 12. Referring to FIG. 4, the electric current pathway 111 looks approximately point-symmetric in the plane view.

Referring to FIG. 2, FIG. 4, and FIG. 5, each of one pair of the terminals 12 is connected to the end of the electric current pathway 111 (electron emission element 11). In addition, one pair of the terminals 12 is extending from the electron emission element 11 and bended toward the Z2-direction. Specifically, the terminal 12 is extending in the approximately orthogonal direction to the electron emission plane of the electron emission element 11. The terminal 12 functions as a connection terminal to energize-heat the electron emission element 11 and to support the electron emission element 11 by being fixed to the electrode bar 15. The terminal 12 is a flat-plate having an approximately same thickness as the thickness (T1) of the electric current pathway 111.

With regard to the terminal 12, the connection member 123 thereof is connected to the electron emission element 11 and the electrode connection member 124 thereof is connected to the electrode bar 15. The connection member 123 and the electrode connection member 124 are connected to each other by the enlargement members 121, 122 in between. Here, according to the aspect of the Embodiment 1, enlargement members 121, 122 have a cross-section area, in which the cross-section area in the orthogonal direction to the extending direction of the terminals 12 is larger than the cross-section area of the electric current pathway 111 in the orthogonal direction to the extending direction of the electric current pathway 111. Specifically, the enlargement members 121, 122 is a flat-plate having a thickness t1 and a width W2. In addition, the width W2 is wider than the pathway width W1 of the electric current pathway 111. Each of the enlargement members 121, 122 has a larger cross-section area S2 than the cross-section area S1 of the electric current pathway 111. Specifically, each of the enlargement members 121, 122 has the cross-section area that is larger than 1-time and smaller than 3-times of the cross-section area of the electric current pathway 111.

In addition, the outer circumference length of the cross-section of the enlargement member 121, 122 in the orthogonal direction to the extending direction of the enlargement member 121, 122 of the terminals 12 is longer than the outer circumference length of the cross-section of the electric current pathway 111 in the orthogonal direction to the extending direction of the electric current pathway 111. Specifically, the surface area of the enlargement member 121, 122 per unit volume is larger than the surface area of the electric current pathway 111 per unit volume.

Referring to FIG. 5, the enlargement member 121 is extending in the first direction (Z-direction) intersecting relative to the electron emission element 11 and the enlargement member 122 is connected to the enlargement member 121 and extending in the second direction (Y-direction) intersecting with the first direction. The connection element 123 and the electrode connection element 124 are extending in the Z-direction as well as the enlargement member 121. In addition, the enlargement member 121, 122 of the terminals 12 are enlarging in the width direction of the orthogonal directions to the extending direction of the flat-plate enlargement member 121, 122. Specifically, the enlargement member 121 is extending in the Y-direction and the enlargement member 122 is enlarging in the Z-direction.

Referring to FIG. 2, the connection element 123 is connected to the electric electron emission element 11. The connection element 123 is in place in a proximity of the connection area between the terminals 12 and the electric current pathway 11. In addition, the connection element 123 has a smaller cross-section area S3 than the cross-section area S2 of the enlargement members 121, 122. Specifically, the connection area 123 is a flat-plate having a thickness t1 and a width W3. In addition, the width W3 is approximately the same as the pathway width W1 of the electric current pathway 111. Specifically, the cross-section area S3 of the connection element 123 is approximately the same as the cross-section area S1 of the electric current pathway 111.

Referring to FIG. 2, two pairs of the support members 13a, 13b that are separately installed from the terminals 12, are insulated against the electrode, and also supporting the electron emission element 11. The support member 13a is in place adjacent to the terminal 12. The support member 13b is in place in the opposite side of the terminal 12 relative to the support member 13a. The support members 13a, 13b, are connected to the electron emission element 11 at the Z1-direction side and connected to the electrode bar 15 at the Z2-direction side. In addition, the support members 13a, 13ba are extending from the electron emission element 11 and bended toward the Z2-direction. Specifically, the support members 13a, 13b are extending in the approximately orthogonal direction to the electron emission plane of the electron emission element 11.

With regard to the support members 13a, 13b, the cross-section area thereof in the orthogonal direction to the extending direction of the support members 13a, 13b is smaller than the cross-section area of the electric current pathway 111 in the orthogonal direction to the extending direction of the electric current pathway 111. Specifically, the support members 13a, 13b are a flat-plate having a thickness t1 and a width W4. In addition, the width W4 is narrower than the pathway width W1 of the electric current pathway 111. Each of the support members 13a, 13b has a smaller cross-section area S4 than the cross-section area S1 of the electric current pathway 111.

The support members 13a, 13b are in place to support a proximity of the deformation area which has a relatively large variation level as to the flat-degree of the electron emission element 11 by the creep deformation along with using the electron emission element 11. In addition, the support member 13a, 13b have a through-hole 131. Accordingly, the cross-section area of the support members 13a, 13b can be made partially small, so that the heat transfer from the electron emission element 11 can be suppressed. In addition, the strength of the support members 13a, 13b can be ensured compared to the case in which the width is narrow without making the through-hole in the support members 13a, 13b.

### EMBODIMENTS

Referring to FIG. 6, the Embodiment according to the aspect of the Embodiment 1 is subjected to a simulation. The point having the highest temperature is located on the electron emission element 11 in the cathode 1. In addition, the temperature of the terminals 12 is lower than in the case of which the enlargement member 121, 122 are not installed. In addition, the temperature of the electron emission element 11 is approximately evenly distributed.

Effect According to the Aspect of the Embodiment 1

The following effects can be obtained according to the aspect of the Embodiment 1.

Here, according to the aspect of the Embodiment 1, the enlargement members 121, 122 having a cross-section area, wherein such cross-section area in the orthogonal direction to the extending direction of the terminals 12 is larger than the cross-section area of the electric current pathway 111 in the orthogonal direction to the extending direction of the electric current pathway 111, are installed to the terminals 12. Accordingly, when the cross-section areas of the enlargement members 121, 122 are large, an electric resistance relative to the enlargement members 121, 122 decreases, so that the heat-generation relative to the terminals 12 on energizing can be lowered. In addition, when the cross-section areas of the enlargement members 121, 122 are large, a heat-conduction amount (heat-dissipation amount) of the enlargement members 121, 122 increases, so that the heat-conduction amount through the terminals 12 of the electron emission element can be large. In addition, when the cross-section areas of the enlargement members 121, 122 are large, the surface area thereof can be made as large, so that the heat emission amount based on the radiation relative to the enlargement members 121, 122 can be large. Therefore, the temperature of the terminals 12 relative to the support members 13a, 13b relative to the support member can be prevented to become relatively high. As results, the temperature rising of the proximity of the area connected to the terminals 12 of the electron emission element 11 can be prevented to become relatively high compared to the temperature of the proximity of the area connected to the support member 13a, 13b of the electron emission element 11, so that the temperature of the electron emission element 11 can be prevented to be uneven. Therefore, the electron emission element 11 can be suppressed to have locally high-temperature, so that a wire-breaking lifetime of the electron emission element 11 can be prevented to be short. In addition, the electron emission element 11 can emit uniform electrons. In addition, the support members 13a, 13b support the electron emission element 11, so that a deformation of the electron emission element 11 can be prevented. Consequently, the temperature of the electron emission element 11 can be prevented to become uneven while preventing the deformation of the electron emission element 11.

In addition, according to the aspect of the Embodiment 1, as set forth above, the outer circumference length of the cross-section of the enlargement member 121, 122 in the orthogonal direction to the extending direction of the enlargement member 121, 122 is longer than the outer circumference length of the cross-section of the electric current pathway 111 in the orthogonal direction to the extending direction of the electric current pathway 111. Accordingly, the surface area of the enlargement members 121, 122 per unit volume can be increased, so that the heat emission amount based on the radiation relative to the enlargement members 121, 122 can be easily increased.

In addition, according to the aspect of the Embodiment 1, as set forth above, the connection element 123 in the proximity of the area connected to the electron emission element 11 of the terminals 12 is formed to have a smaller cross-section area than the enlargement members 121, 122. Accordingly, the cross-section area of the bend portion can be prevented to become large when forming in a unified manner by bending the border between the electron emission element 11 and the terminal 12, so that such bending can be achieved easily. In addition, when the cathode 1 is covered with a cover 14, it can be prevented that the connection element 123 of the terminals 12 interferes in the cover 14.

In addition, according to the aspect of the Embodiment 1, as set forth above, the enlargement member 121, 122 are enlarging in the width direction of the orthogonal directions to the extending direction of the flat-plate enlargement member 121, 122. Therefore, the terminals 12 are formable into the flat-plate having approximately the same thickness, so that the enlargement members 121, 122 can be easily formed.

In addition, according to the aspect of the Embodiment 1 as set forth above, the enlargement member 121 that is extending in the first direction (Z-direction) intersecting relative to the electron emission element 11, and the enlargement member 122 that is connected to the enlargement member 121 and extending in the second direction (Y-direction) intersecting with the first direction, are installed. Accordingly, the volume combining both enlargement members 121, 122 can be increased, so that it can be effectively prevented that the temperature of the terminals 12 becomes relatively high.

In addition, according to the aspect of the Embodiment 1, as set forth above, the support members 13a, 13b are formed so that the cross-section area in the orthogonal direction to the extending direction of the support members 13a, 13b is smaller than the cross-section area of the electric current pathway 111 in the orthogonal direction to the extending direction of the electric current pathway 111. Accordingly, a heat dissipation from the electron emission element 11 via the support members 13a, 13b can be prevented, so that it can be prevented that the temperature of the proximity of the area connecting the support members 13a, 13b of the electron emission element 11 becomes relatively low compared to the temperature of the proximity of the area connected to the terminals 12 of the electron emission element 11. Consequently, the temperature of the electron emission element can be prevented to become uneven.

In addition, according to the aspect of the Embodiment 1 as set forth above, the terminals 12, and the support members 13a, 13b are extending in the approximately orthogonal direction to the electron emission plane of the electron emission element 11. Accordingly, the terminals 12, the support members 131, 13b can be in place in the deformation direction of the electron emission element 11, so that a deformation of the electron emission element 11 can be effectively prevented.

In addition, according to the aspect of the Embodiment 1, as set forth above, each of the enlargement members 121, 122 has the cross-section area that is larger than 1-time and smaller than 3-times of the cross-section area of the electric current pathway 111. Accordingly, the cross-section areas of the enlargement members 121, 122 is larger than 1-time of the cross-section area of the electric current pathway, so that the temperature of the terminals 12 including the enlargement members 121, 122 can be prevented to rise. In addition, the cross-section areas of the enlargement members 121, 122 is smaller than 3-times of the cross-section area of the electric current pathway, so that the cathode 1 including the terminals 12 can be prevented to be big.

In addition, according to the aspect of the Embodiment 1, as set forth above, the electron emission element 11, the terminals 12, the support members 13a, 13b are made of the same materials in a unified manner. Accordingly, the cathode including the electron emission element 11, the terminals 12, the support members 131, 13b can be formed easily.

In addition, according to the aspect of the Embodiment 1, as set forth above, the support members 13a, 13b are in place to support a proximity of the deformation area of the electron emission element 11, which has a relatively large variation level as to the flat-degree of the electron emission element 11 by the creep deformation along with using the electron emission element 11. Accordingly, the proximity of the deformation area, in which the variation of the flat-degree is large, is supported, so that the deformation (sag phenomenon) of the electron emission element 11 can be effectively prevented.

### Embodiment 2

Next, referring to FIG. 7, the inventor illustrates a cathode 201 according to the aspect of the Embodiment 2 of the present invention. According to the aspect of the Embodiment 2, the inventor sets forth the aspect of the Embodiment in which one pair of the support members is installed instead of two pairs of support members according to the aspect of the Embodiment 1. Further, the same element as illustrated according to the aspect of the Embodiment 1 is not set forth while providing the identical reference sign.

Referring to FIG. 7, the cathode 201, according to the aspect of the Embodiment 2, that is made of pure tungsten or a tungsten alloy comprises a flat-plate shape electron emission element 11, one pair of terminals 210, and one pair of support members 200 in a unified manner. Specifically, the electron emission element 11, the terminals 210, the support members 220 are made of the same materials in a unified manner. According to the Embodiment 2, the electron emission element 11, one pair of the terminals 210, one pair of the support members 220 are cutout from a single flat-plate material by using a laser and formed by a bending work in a unified manner. The electron emission element 11 comprises an electric current pathway 111. The terminals 210 comprises an enlargement member 211, and a connection element 212 and an electrode connection element 213.

With regard to the terminal 210, the connection element 212 thereof is connected to the electron emission element 11 and the electrode connection element 213 thereof is connected to the electrode bar 15. The connection element 212 and the electrode connection element 213 are connected thereto by the enlargement element 211 in between. Here, according to the aspect of the Embodiment 2, enlargement elements 211 of the terminal 210 have a cross-section area, in which the cross-section area in the orthogonal direction to the extending direction of the terminals 210 is larger than the cross-section area of the electric current pathway 111 in the orthogonal direction to the extending direction of the electric current pathway 111. Specifically, the connection area 211 is a flat-plate having a thickness t1 and a width W21. In addition, the width W21 is wider than the pathway width W1 of the electric current pathway 111. The enlargement element 211 has a larger cross-section area S21 than the cross-section area S1 of the electric current pathway 111.

One pair of the support members 220 that are separately installed from the terminals 210, are insulated against the electrode, and also supporting the electron emission element 11. The support member 220 is in place adjacent to the terminal 210. The support member 220 is formed to be bendable. Accordingly, the distance between the terminal 210 and the support member 220 can be set up long, so that the work to install the cathode 201 to the electrode bar 15 can be easily carried out.

In other structural elements according to the aspect of the Embodiment 2 is the same as the aspect of the Embodiment 1 as set forth above.

Effect According to the Aspect of the Embodiment 2

The following effect can be obtained according to the aspect of the Embodiment 2.

As set forth above, according to the aspect of the Embodiment 2 as well as the Embodiment 1, the enlargement members 211 having a cross-section area, wherein such cross-section area in the orthogonal direction to the extending direction of the terminals 210 is larger than the cross-section area of the electric current pathway 111 in the orthogonal direction to the extending direction of the electric current pathway 111, is installed to the terminals 210. Consequently, the temperature of the electron emission element 11 can be prevented to become uneven while preventing the deformation of the electron emission element 11.

Other effects according to the aspect of the Embodiment 2 is the same as the aspect of the Embodiment 1 as set forth above.

### Embodiment 3

Next, referring to FIG. 8, the inventor sets forth the cathode 301 according to the aspect of the Embodiment 3 of the present invention. According to the aspect of the Embodiment 3, the inventor sets forth the aspect of the Embodiment in which an enlargement member enlarging in the thickness direction is installed to the terminal instead of the structure, in which the enlargement member enlarging in the width direction is installed to the terminal according to the aspect of the Embodiment 1 and the aspect of the Embodiment 2 as set forth above. Further, the same element as illustrated according to the aspect of the Embodiment 1 is not set forth while providing the identical reference sign.

Referring to FIG. 8, the cathode 301, according to the aspect of the Embodiment 3, that is made of pure tungsten or a tungsten alloy comprises a flat-plate shape electron emission element 11, one pair of terminals 310, and two pairs of support members 320, 330 in a unified manner. Specifically, the electron emission element 11, the terminal 310, the support members 320, 330 are made of the same materials in a unified manner. According to the Embodiment 3, the electron emission element 11, one pair of the terminals 310, two pairs of the support members 320, 330 are cutout from a single flat-plate material by using a laser and formed by a bending work in a unified manner. In addition, an etching work reduces the thickness of other members than the enlargement member 311, 312 of the terminal 310. The electron emission element 11 comprises an electric current pathway 111. The terminal 310 comprises enlargement members 311, 312, a connection element 313 and an electrode connection member 314. Further, the enlargement structural elements 311, 312 are respectively examples of a “first structural element” and a “second structural element” in the claims.

With regard to the terminal 310, the connection member 313 thereof is connected to the electron emission element 11 and the electrode connection member 314 thereof is connected to the electrode bar 15. The connection member 313 and the electrode connection member 314 are connected thereto by the enlargement members 311, 312 installed in between. Here, according to the aspect of the Embodiment 3, enlargement members 311, 312 have a cross-section area, in which the cross-section area in the orthogonal direction to the extending direction of the terminals 310 is larger than the cross-section area of the electric current pathway 111 in the orthogonal direction to the extending direction of the electric current pathway 111. Specifically, the enlargement members 311, 312 are flat-plates having a thickness t2 and a width W31. In addition, the thickness t2 is thicker than the thickness t1 of the electric current pathway 111. In addition, the width W31 is approximately the same as the pathway width W1 of the electric current pathway 111. Each of the enlargement members 311, 312 has a larger cross-section area S31 than the cross-section area S1 of the electric current pathway 111. Specifically, the enlargement member 311, 312 are enlarging in the thickness direction of the orthogonal directions to the extending direction of the flat-plate enlargement member 311, 312.

Two pairs of the support members 320, 330 that are separately installed from the terminals 310, are insulated against the electrode, and also supporting the electron emission element 11. The support member 320 is in place adjacent to the terminal 310. The support member 330 is in place in the opposite side of the terminal 310 relative to the support member 320. The support members 320, 330 are connected to the electron emission element 11 at the Z1-direction side and connected to the electrode bar 15 at the Z2-direction side. In addition, the support members 320, 330 are extending from the electron emission element 11 and bended toward the Z2-direction.

In other structural elements according to the aspect of the Embodiment 3 is the same as the aspect of the Embodiment 1 as set forth above.

Effect According to the Aspect of the Embodiment 3

The following effect can be obtained according to the aspect of the Embodiment 3.

As set forth above, according to the aspect of the Embodiment 3 as well as the Embodiment 1, the enlargement members 311, 312 having a cross-section area, wherein such cross-section area in the orthogonal direction to the extending direction of the terminals 310 is larger than the cross-section area of the electric current pathway 111 in the orthogonal direction to the extending direction of the electric current pathway 111, is installed to the terminals 310. Consequently, the temperature of the electron emission element 11 can be prevented to become uneven while preventing the deformation of the electron emission element 11.

In addition, according to the aspect of the Embodiment 3, as set forth above, the enlargement member 311, 312 are enlarging in the thickness direction of the orthogonal directions to the extending direction of the flat-plate enlargement member 311, 312. Accordingly, the thickness of the enlargement members 311, 312 increases in the thickness direction, so that the cross-section area of the enlargement member 311, 312 can be easily increased.

Other effects according to the aspect of the Embodiment 3 is the same as the aspect of the Embodiment 1 as set forth above.

### Embodiment 4

Next, referring to FIG. 9, the inventor illustrates the cathode 401 according to the aspect of the Embodiment 4 of the present invention. According to the aspect of the Embodiment 4, the inventor sets forth the aspect of the Embodiment in which an enlargement member is enlarging in both width direction and thickness direction instead of the structure according to the aspect of the Embodiment 3, in which the enlargement member is enlarging in the width direction according to the aspect of the Embodiment 1 and Embodiment 2 as set forth above, and is enlarging in the thickness direction according to the aspect of the Embodiment 3 as set forth above. Further, the same element as illustrated according to the aspect of the Embodiment 1 is not set forth while providing the identical reference sign.

Referring to FIG. 9, the cathode 401, according to the aspect of the Embodiment 4, that is made of pure tungsten or a tungsten alloy comprises a flat-plate shape electron emission element 11, one pair of terminal elements 410, and two pairs of support elements 420, 430 in a unified manner. Specifically, the electron emission element 11, the terminal 410, the support members 420, 430 are made of the same materials in a unified manner. According to the Embodiment 4, the electron emission element 11, one pair of the terminals 410, two pairs of the support members 420, 430 are cutout from a single flat-plate material by using a laser and formed by a bending work in a unified manner. In addition, an etching work reduces the thickness of other members than the enlargement member 411, 412 of the terminal 410. The electron emission element 11 comprises an electric current pathway 111. The terminal 410 comprises enlargement members 411, 412, a connection element 413, and an electrode connection member 414. Further, the enlargement structural elements 411, 412 are respectively examples of a “first member” and a “second member” in the claims.

With regard to the terminal 410, the connection element 413 thereof is connected to the electron emission element 11 and the electrode connection element 414 is connected to the electrode bar 15. The connection member 413 and the electrode connection member 414 are connected thereto by the enlargement members 411, 412 installed in between. Here, according to the aspect of the Embodiment 4, enlargement members 411, 412 have a cross-section area, in which the cross-section area in the orthogonal direction to the extending direction of the terminals 410 is larger than the cross-section area of the electric current pathway 111 in the orthogonal direction to the extending direction of the electric current pathway 111. Specifically, the enlargement members 411, 412 are flat-plates having a thickness t2 and a width W41. In addition, the thickness t2 is thicker than the thickness t1 of the electric current pathway 111. In addition, the width W41 is wider than the pathway width W1 of the electric current pathway 111. Each of the enlargement members 411, 412 has a larger cross-section area S41 than the cross-section area S1 of the electric current pathway 111. Specifically, the enlargement member 411, 412 are extending in both width direction and thickness direction of the orthogonal directions to the extending direction of the flat-plate enlargement member 411, 412.

Two pairs of the support members 420, 430 that are separately installed from the terminals 410, are insulated against the electrode, and also supporting the electron emission element 11. The support member 420 is in place adjacent to the terminal 410. The support member 430 is in place in the opposite side of the terminal 410 relative to the support member 420. The support members 420, 430 are connected to the electron emission element 11 at the Z1-direction side and connected to the electrode bar 15 at the Z2-direction side. In addition, the support members 420, 430 are extending from the electron emission element 11 and bended toward the Z2-direction.

In other structural elements according to the aspect of the Embodiment 4 is the same as the aspect of the Embodiment 1 as set forth above.

Effect According to the Aspect of the Embodiment 4

The following effect can be obtained according to the aspect of the Embodiment 4.

As set forth above, according to the aspect of the Embodiment 4 as well as the Embodiment 1, the enlargement members 411, 412 having a cross-section area, wherein such cross-section area in the orthogonal direction to the extending direction of the terminals 410 is larger than the cross-section area of the electric current pathway 111 in the orthogonal direction to the extending direction of the electric current pathway 111, is installed to the terminals 410. Consequently, the temperature of the electron emission element 11 can be prevented to become uneven while preventing the deformation of the electron emission element 11.

Other effects according to the aspect of the Embodiment 4 is the same as the aspect of the Embodiment 1 as set forth above.

### Alternative Embodiment

In addition, the aspects of the Embodiments and the Embodiments disclosed at this time are examples and not limited thereto in any points. The scope of the present invention is specified in the claims but not in the above description of the aspect of the Embodiments and all alternative (alternative Embodiments) are included in the scope of the claims and equivalents thereof.

For example, according to the aspect of the Embodiments 1 to the Embodiment 4 as set forth above, the example of the structure using the cathode of the present invention in the X-ray tube device is described, but the present invention is not limited thereto. According to the present invention, the cathode can be applied to other devices than the X-ray tube device.

In addition, according to the aspect of the Embodiments 1 to the Embodiment 4 as illustrated above, the support member is formed with the electric current pathway (electron emission element) in a unified manner, but the present invention is not limited thereto. According to the present invention, the support member can be installed separately from the electric current pathway (electron emission element). In addition, the support member is formed in a different manner from the electron emission element, so that the support member can be made of a different material (other materials than tungsten and tungsten alloy). In such case, the support member can be made of a high-melting point metal such as molybdenum and so forth other than tungsten, or a ceramic material such as alumina (Al₂O₃) and silicon nitride (Si₃N₄).

In addition, according to the aspect of the Embodiment 1-4 as set forth above, the terminal and the support member are flat-plates, but the present invention is not limited thereto. According to the present invention, the terminal and the support member can be any shape other than a flat-plate shape. For example, the terminal and the support member can have a column-shape and so forth.

In addition, according to the aspects of the Embodiments 1 to the Embodiment 4 as illustrated above, the electron emission element looks a circle in a plane view as an example, but the present invention is not limited thereto. According to the present invention, the electron emission element can be just a flat-plate, the shape of the electron emission element in the plane view can be a rectangular flat-plate or a polygonal flat-plate.

In addition, according to the aspects of the Embodiment 1 to the Embodiment 4 as set forth above, the terminal and the support members are extending in the approximately orthogonal direction to the electron emission plane of the electron emission element, but the present invention is not limited thereto. According to the present invention, referring to FIG. 10, the terminal and the support member can be formed approximately in the same direction as the direction in which the electron emission plane of the electron emission element is extending. Specifically, according to the aspect of the alternative Embodiment referring to FIG. 10, the cathode 501 comprises the flat-plate electron emission element 11 and one pair of terminals 510, two pairs of support members 520, 530. In addition, the terminal 510 comprises enlargement members 511, 512, a connection element 513, and an electrode connection member 514. And, the electron emission element 11, the terminal 510, the support members 520, 530 are formed approximately on the same plane as a flat-plate.

In addition, according to the aspect of the Embodiments 1 to the Embodiment 4 as illustrated above, the support member is extending in the same side of the terminal, but the present invention is not limited thereto. According to the present invention, the support member can be extending in a different side from the side of the terminal. For example, the support member can extend alongside of the cathode (in the parallel direction to the flat-plate electron emission element).

In addition, according to the aspect of the Embodiments 1, the Embodiment 3, the Embodiment 4 as set forth above, two pairs (four) of the support members are installed, and according to the aspect of the Embodiment 2, one pair (two) of the support members is installed, but the present invention is not limited thereto. One, three or more than five support members can be installed. However, when the number of the support members is large, the heat of the electron emission element escapes to the support member on energizing and heating, so that the temperature distribution of the electron emission element can be uneven. Accordingly, the number of the support member should be a satisfactory number to support the electron emission element and such number should be preferably as little as possible.

### REFERENCE OF SIGNS

1, 201, 301, 401, 501 Cathode
2 Target (Anode)
3 Electron emission element
12, 210, 310, 410 Terminal
13a, 13b, 220, 320, 330, 420, 430, 520, 530 Support member
111 Electric current pathway
121, 311, 411, 511 Enlargement member (first member)
122, 312, 412, 512 Enlargement member (second member)
211 Enlargement member
100 X-ray tube device

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1-7. (canceled)

8. A cathode, of an X-ray tube device that emits an electron toward an anode, comprising:
an electron emission element that has an electric current pathway formed into a flat-plate, and emits an electron by energizing and heating;
one pair of terminals that extends respectively from said electron emission element, and is connected to an electrode;
a support member that is separately installed from said terminals, insulated against said electrode, and supports said electron emission element; and
said terminals further comprising:
an enlargement member having a cross-section area, wherein:
said cross-section area in an orthogonal direction to an extending direction of said terminals is larger than a cross-section area of said electric current pathway in an orthogonal direction to an extending direction of said electric current pathway; and
said terminal is formed so that a cross-section area of a proximity of a portion that is connected to said electron emission element is smaller than of said enlargement member, and said support member is formed so that a cross-section area, which is connected to said electron emission element of said terminal, is smaller than the cross-section area of a proximity of a portion in an orthogonal direction to a direction in which said support member extends.

9. The cathode, according to the claim 8, wherein:
said pair of terminals is formed into a flat-plate shape, and an outer circumference length of the cross-section of said enlargement member in the orthogonal direction to the extending direction of said enlargement member is longer than an outer circumference length of a cross-section of said electric current pathway in the orthogonal direction to the extending direction of said electric current pathway.

10. The cathode, according to the claim 8, wherein:
said enlargement member is formed into a flat-plate shape and enlarges in at least one of a width direction and a thickness direction each of which are orthogonal to the extending direction of said flat-plate enlargement member.

11. The cathode, according to the claim 8, wherein:
said enlargement member, further comprises:
a first member extending in a first direction intersecting relative to said electron emission element and a second member connected to said first member is extending in a second direction intersecting with said first direction.

12. The cathode, according to the claim 8, wherein:
said support member is formed so that a cross-section area in the orthogonal direction to the extending direction of said support member is smaller than the cross-section area of said electric current pathway in the orthogonal direction to the extending direction of said electric current pathway.

13. An X-ray tube device, comprising:
an anode;
a cathode that emits an electron to said anode;
said cathode, further comprising:
an electron emission element that has an electric current pathway formed into a flat-plate, and emits an electron by energizing and heating;
one pair of terminals that extends respectively from said electron emission element, and is connected to an electrode; and
a support member that is separately installed from said terminals, insulated against said electrode, and supports said electron emission element; and
said terminals further, comprising:
an enlargement member having a cross-section area, wherein said cross-section in an orthogonal direction to an extending direction of said terminals is larger than a cross-section area of said electric current pathway in an orthogonal direction to an extending direction of said electric current pathway; and said terminal is formed so that a cross-section area of a proximity of a portion that is connected to said electron emission element is smaller than of said enlargement member, and said support member is formed so that a cross-section area is smaller than the cross-section area of a proximity of a portion, which is connected to said electron emission element of said terminal, in an orthogonal direction to a direction in which said support member extends.
